(19) United States
(12) Patent Application Publication
(10) Pub. No.: US 2010/0306537 A1
(43) Pub. Date: Dec. 2, 2010

(54) SECURE MESSAGING

(75) Inventor: Ram Cohen, Tel Aviv (IL)

Correspondence Address: ROBERT G. LEV, 4766 MICHIGAN BLVD., YOUNGSTOWN, OH, 44505, US

(73) Assignee: PostalGuard Ltd., Petah Tikva (IL)

(21) Appl. No.: 12/734,814

(22) PCT Filed: Nov. 24, 2008
(86) PCT No.: PCT/IL2008/001540

§ 371 Date: May 24, 2010

(30) Foreign Application Priority Data
Nov. 25, 2007 (IL) 187624

(51) Int. Cl. H04L 9/32

(52) U.S. Cl. 713/168

(57) ABSTRACT

A method for securely transmitting a message to a recipient whilst allowing subsequent access to the message content, wherein at least part of the message is encrypted, comprising the steps of: (a) encrypting a first piece of content with an encryption key; (b) providing a decryption engine at an address on a recipient accessible server; (c) incorporating the address of the recipient accessible server within the message, together with the first piece of encrypted content; (d) transmitting the first piece of encrypted content together with the address of the recipient accessible server to the recipient, such that the recipient is able to decrypt the first piece of content by uploading it to the decryption engine, and (e) authenticating the sender to the recipient.

### FIELD OF THE INVENTION

Email is widely used to transfer information, particularly messages, over a network. Where sender and recipient share a Local Area Network (LAN) that is wholly internal within a company, security is rarely an issue. When, however, sensitive information is sent over a public network, such as the Internet, email security is of tremendous importance. Sensitive information may be of a personal nature, including credit card details, medical records and the like. Much confidential company business information is also regularly sent and received by email. Such information includes, inter alia, financial records and forecasts, business intelligence, customer records and trade secrets.

Encryption is one widely used technique for securing email. However, the recipient is required to decrypt emails received, and needs access to appropriate software to do so. Service providers that have a large number of customers often prefer not to install software on their customers' computers as doing so requires substantial infrastructure to provide appropriate support.

One approach to this dilemma is to use standard encryption mechanisms whose decryption software is built into email programs, operating systems or standard software generally already installed on customer's computers, or at least widely available.

Current e-mail applications only support built in encryption/decryption of SMIME. In consequence, private/public keys are required which greatly complications things. Other software packages that are widely used for e-mailing, such as PDF and Zip, for example, suffer from poor encryption quality and/or susceptibility to attack from malicious code.

Where used for communicating between personnel in different companies, e-mails must be able to pass through anti-virus programs and firewalls installed on gateways, and such programs must be able to adequately deal with malware threats. However encryption of emails usually results in encryption of the attachments as well. Encrypted viruses, Trojans and other malware, defeat gateway firewalls.

S/MIME, an acronym for Secure/Multipurpose Internet Mail Extensions, is a standard for the private/public key encryption and signing of e-mail encapsulated in MIME. It is incorporated within the vast majority of e-mail software packages and provides authentication, message integrity and non-repudiation of origin by the use of digital signatures, privacy and data security. Before S/MIME can be used however, it is necessary to obtain and install an individual key/certificate. Preferably, separate private keys and associated certificates are used for Signature and for Encryption. While it is technically possible for an uncertified sender to send an encrypted message, S/MIME clients require senders to install their own certificates before they allow them to encrypt data to be sent to others. It will be appreciated that in general, the use of Private-Public Key software is complicated and thus solutions incorporating this technology are not ideal.

Another approach is to encrypt a message, and to send it together with the decryption algorithm, perhaps as JavaScript, packaged into an HTML file. This solution often fails however, since the gateway security server typically removes the decryption algorithm before allowing the message to pass.

Encrypted PDFs offer another solution. While the recipient is required to install an appropriate PDF reader, such readers are widely available and for all intents and purposes, can be considered as ‘built in’. However, encrypted PDF files also pose the security risks discussed hereinabove, in that they allow malicious code to enter an organization without being properly scanned so these files are usually blocked by gateway security products.

A further solution that has been proposed, which addresses the problem of secure delivery of messages to a recipient, involves storing the content of the email on a server and sending an email comprising the URL of the content to the addressee, rather than the content itself. Essentially, the addressee accesses the email using web browsing software such as Microsoft Explorer™ or Firefox™, for example, or even using the primitive browsers available on mobile phones. After authenticating himself, via a password, for example, the recipient then receives the content of the message. One disadvantage of such a system is that the recipient does not have a typical email experience. A further disadvantage is that the sender is required to store the message in an accessible manner on his server for extended periods of time in an unencrypted form, which is, itself, a security risk.

U.S. Pat. No. 7,266,847 to Matthew et al. titled “Secure message system with remote decryption service”, which is incorporated herein by reference, relates to a method for providing recipients with access to message content, involving uploading encrypted message content to a remote decryption service for decrypting the message and provided access to the decrypted message. Essentially, an email message including both encrypted data and a specific server address or URL is sent to the recipient. The recipient then posts the encrypted data at the specified address and provides a decryption key or some kind of authentication credentials such as a password, etc. Once the recipient has authenticated himself, the server decrypts the message and displays it to the recipient. Matthews' system relates to recipient authentication and to transmission of encrypted messages to a recipient not required to have decryption software installed on his system. There are, however, no features that ensure the authenticity of the transmitted message and the authenticity of the sender. This is disadvantageous since the encryption used may defeat malware detecting software and thus the solution may be used to disseminate malware.

Because of the disadvantages of prior art solutions, such as those described hereinabove, there is still a need for secure e-mail messaging in a manner that protects the recipient from malware, that does not interfere with gateway security measures, and that does not require special software on the recipient's system, and embodiments of the present invention address these needs.

### SUMMARY OF THE INVENTION

Essentially the present invention is directed to methods of safe email communication with a recipient, using data encryption but not requiring the recipient to have decryption software installed on his system, wherein the sender authenticates himself to the recipient. Specifically, The present invention is directed to providing a method for securely transmitting a message to a recipient whilst allowing subsequent access to the message content, wherein at least part of the message is encrypted, comprising the following steps: (a) encrypting a first piece of content with an encryption key; (b) providing a decryption engine at an address on a recipient accessible server; (c) incorporating the address of the recipient accessible server within the message, together with the first piece of encrypted content; (d) transmitting the first piece of encrypted content together with the address of the recipient accessible server to the recipient, such that the recipient is able to decrypt the first piece of content by uploading it to the decryption engine, further comprising the step (e) of authenticating the sender to the recipient.

Optionally, the message content is viewable by the recipient using a web-browser.

In some embodiments, the decryption key is held at an address on the recipient accessible server.

Typically, the encryption and decryption keys are selected from the group comprising symmetrical key pairs and asymmetrical key pairs.

Optionally, the encryption and decryption keys comprise a one time key pair.

Optionally, the message further comprises a unique identifier.

Optionally, the first piece of message content is encrypted together with a unique identifier prior to storage on the decryption server for authentication of the sender.

In some embodiments, at least part of the transmitted message is hashed; the hashed part being accessible to the decryption server allowing confirmation of the authenticity of the transmitted message.

Optionally, the hashed part is previously encrypted. Alternatively, the hashed part is not encrypted.

Optionally, the message is encrypted by the sender with an encryption key and the corresponding decryption key is made available to the decryption server.

Optionally, the encryption and decryption keys are selected from the group comprising a symmetrical key pair and an asymmetrical key pair.

In some embodiments, the decryption server notifies the sender upon displaying the message to the recipient, thereby certifying that said message was delivered and displayed.

Optionally, at least one further piece of encrypted content is stored on at least one further internet address accessible to the decryption server, such that decryption is possible only after assembling all pieces of encrypted data.

Optionally, the step of authentication comprises comparing data sent in the uploaded data to the decryption server with data accessible to the decryption server.

### BRIEF DESCRIPTION OF FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a schematic block diagram of a sender and a recipient in data communication via a network such that the sender may transfer information to the recipient via the Network.

FIG. 2 is a flowchart illustrating one method of the invention;

FIG. 3 is a schematic illustration of a form for displaying an encrypted to the recipient of an email, and

FIG. 4 is a schematic illustration of an email displayed a decrypted email on a website.

### DESCRIPTION OF THE PREFERRED EMBODIMENTS

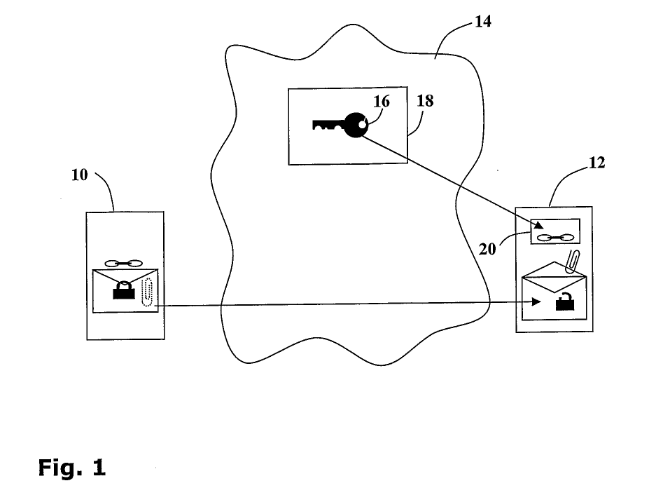

With reference to FIG. 1, in a typical messaging scenario a sender's system 10 is required to send a message, such as an email to a recipient' system 12 via a network. A sender wishing to send encrypted content from the sender's system 10 to a recipient' system 12 via a network 14, typically the Internet, may send a link to a decryption program 16 hosted at an address supported by a server 18, typically by sending the URL of a page of a website. In this manner, the recipient's system 12 is merely required to support an Internet browser application 20, such as Netscape or explorer, or even a simplified Internet browser such as provided with mobile phones, Personal Digital Assistants (PDAs), and the like. Thus unlike conventional encrypted email, in the present invention some of the content of a message is encrypted using a recipient encryption key which may be symmetrical or asymmetrical. The encrypted data together with a reference to a decryption server is sent to the recipient. On receiving the message, the recipient opens the message and sends the encrypted data together with the decryption key to the decryption server at an address specified in the message, for decryption thereat. The decrypted message may then be sent to the recipient, but typically will be displayed to the recipient at a recipient accessible URL, via a network browser, such as Netscape or Microsoft Explorer, for example.

This type of solution is known. For example, it is described in more detail in U.S. Pat. No. 7,266,847 to Matthew et al. The advantages of encryption are provided, but, in contrast to the more typical prior art encrypted email solutions, the solution does not require the sender ensuring that the recipient's system 12 has appropriate decryption software installed thereupon. It will be appreciated that not having to distribute and maintain decryption software at customers' sites is advantageous to senders. Since the decryption code is not sent to the recipient, but instead, is stored on a recipient accessible server 18, the message sent does not generally include embedded code which is often removed by antivirus programs and the like. Since the data is transmitted in the email it does not require storage at the sender side for long periods of time, which can be troublesome in some scenarios, such as where messages are sent to a large client base, such as by banks and the like. In this manner, the sender does not incur large storage and backup costs.

The encryption key need not be very sophisticated and may simply comprise a password and/or the recipient's email or the like. The decryption key is typically saved at the decryption server, but the content of the email message is not saved on the decryption server at all. Rather it is incorporated into the email and sent from sender to recipient, but in encrypted form.

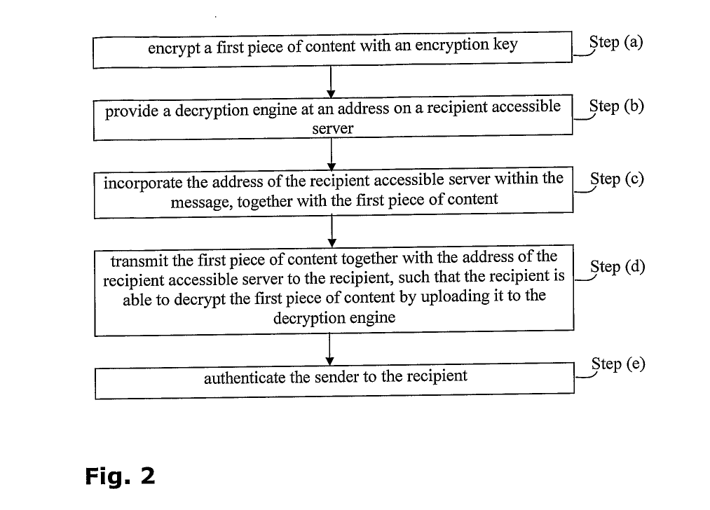

The present invention provides an encryption system and method with decryption software supported remotely, in a manner that is accessible to the recipient via the network. With reference to FIG. 2, the present invention is directed to a method for securely transmitting message content to a recipient with access to message content wherein at least part of the message is encrypted, comprising the following steps:

(a) encrypting a first piece of content with an encryption key; (b) providing a decryption engine at an address on a recipient accessible server; (c) incorporating the address of the recipient accessible server within the message, together with the first piece of content; (d) transmitting the first piece of content together with the address of the recipient accessible server to the recipient, such that the recipient is able to decrypt the first piece of content by uploading it to the decryption engine, and (e) authenticating the sender to the recipient.

The recipient typically uploads the message to the decryption server and reads the email at a URL via recipient's web-browser.

The basic idea of sending an email comprising encrypted data and a link such as a URL to a server address for decoding the e-mail is discussed in U.S. Pat. No. 7,266,847 to Matthew et al. The main advantage is that the recipient is not required to have special decryption software preinstalled on his system. The encryption/decryption may use a symmetrical key pair or an asymmetrical key, and the decryption key itself pair may be incorporated within the message or held at the address on the recipient accessible server.

However, U.S. Pat. No. 7,266,847 to Matthew et al. does not address the issue of sender authentication. Recipients are, however, extremely wary of running executable code within an email for fear of malware attack. Encrypted emails may get through gateway security measures and thus it is often necessary to ensure that an encrypted message originates from the alleged sender. The authentication step (e) is a particular feature of methods of the invention and is not disclosed in U.S. Pat. No. 7,266,847 to Matthew et al.

In preferred embodiments of the invention, only part of the content of the message is incorporated within the email. At least one further piece of encrypted content is stored on at least one further internet address accessible to the decryption server, such that decryption is possible only after assembling all pieces of encrypted data.

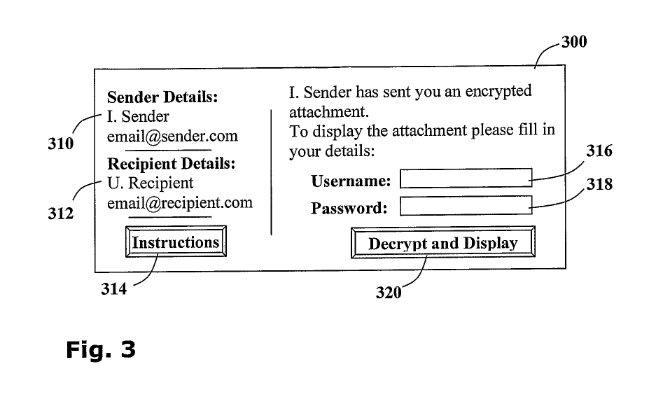

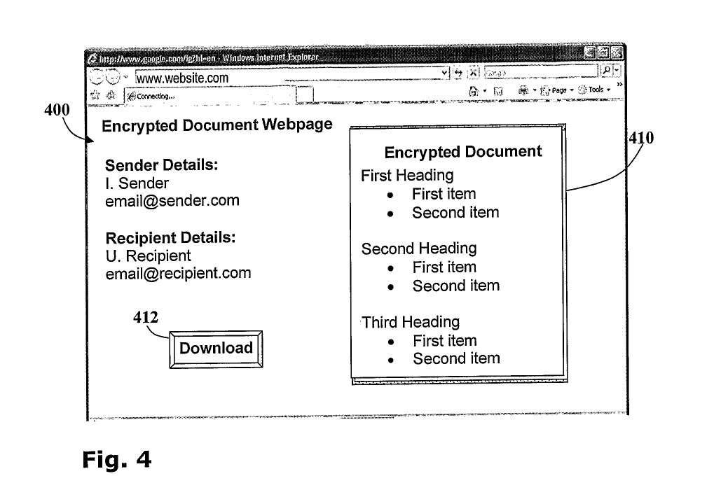

As shown in FIG. 3, in one implementation, the message is displayed to the recipient as a form 300, such as is common with Windows type interfaces. Details of Intended Recipient 310 and Sender 312 are shown, together with a button 314 for displaying instructions to the recipient, explaining the purpose and features of the system. The form 300 will typically include fields for the recipient to identify himself by typing in his user name 316 and password 318, or other decryption keys, for example. On clicking a decrypt and display key 320, an Internet browser on the recipient's system 12, opens an appropriate web page 400 for viewing content thereupon (FIG. 4).

With reference to FIG. 4, in one implementation, activation of the remote decryption server causes a web page 400 to be displayed to the recipient. Message content is displayed in a field 410 on the webpage and optionally and preferably, the recipient is able to click an appropriate key 412 to download the displayed, decrypted content to the recipient's system 12 (FIG. 1).

The decrypted content may be downloaded over a secure communication channel such as an SSL (Secure socket layer), such as is used by virtually all web browsers and does not require any key on the recipient side.

In preferred embodiments of the invention, only part of the content of the message is incorporated within the email. At least one further piece of encrypted content is stored on at least one further internet address 20, accessible to the decryption server 18 such that decryption is only possible after all the pieces of decrypted data are assembled.

In one embodiment, the first piece of message content is encrypted together with a unique identifier prior to storage on the decryption server 18 for authentication of the sender. Optionally and preferably, at least part of the transmitted message is hashed. When the recipient posts the message at the decryption server 18, the decryption server 28 accesses hashed data at a server accessible URL, such as in a database 20, for example. By confirming that the posted hashed data and the hashed data accessed at the URL match, the decryption server 18 is able to confirm the authenticity of the transmitted message. In this manner, the recipient is able to eliminate the risk of opening encrypted malware piggybacked onto a message sent by a hostile sender. The hashed part may be previously encrypted but need not be encrypted.

Other security features may be provided. In some embodiments, the encryption key of the recipient is encrypted by the sender with a one time key and the decryption key is made available to the decryption server. As in Matthew's system, the message may be broken up into pieces, each of which being placed into a GIF tag.

It is a feature of embodiments of the invention that the decryption server is able to notify the sender that the decrypted message has been displayed to the recipient, thereby certifying that said message was delivered and displayed. Such a feature is not described in U.S. Pat. No. 7,266,847 to Matthew et al., and is not supported by the system described therein, since Matthew's system allows recipients to have decryption software on their systems, providing Internet access to such software on a remote decryption server as being an option only, whereas embodiments of the improved system described herein, not only allow, but also require using a remote decryption system.

In essence therefore, embodiments of the present invention allow recipients to receive and view encrypted emails without having decryption software installed on their systems. Instead, the recipient uploads the content to a remote decryption server, perhaps via the Internet. The decrypted content may be downloaded by the recipient to his system from an appropriate URL, or may be displayed on a web-page and viewed by recipient using his Internet browser. Since the recipient does not need to preinstall decryption software, the methods described hereinabove are ideal for one to accessing and view encrypted email when a guest on someone else's system, or for accessing and viewing emails from an Internet café or the like.

Thus the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A method for securely transmitting a message to a recipient whilst allowing subsequent access to the message content, wherein at least part of the message is encrypted, comprising the following steps:
(a) encrypting a first piece of content with an encryption key;
(b) providing a decryption engine at an address on a recipient accessible server;
(c) incorporating the address of the recipient accessible server within the message, together with the first piece of encrypted content;
(d) transmitting the first piece of encrypted content together with the address of the recipient accessible server to the recipient, such that the recipient is able to decrypt the first piece of content by uploading it to the decryption engine,
further comprising the step (e) of authenticating the sender to the recipient.

2. The method of claim 1, wherein the message content is viewable by the recipient using a web-browser.

3. The method of claim 1 wherein the decryption key is held at an address on the recipient accessible server.

4. The method of claim 1 wherein the encryption and decryption keys are selected from the group comprising symmetrical key pairs and asymmetrical key pairs.

5. The method of claim 1 wherein the encryption and decryption keys comprise a one time key pair.

6. The method of claim 1, wherein the message further comprises a unique identifier.

7. The method of claim 1, wherein the first piece of message content is encrypted together with a unique identifier prior to storage on the decryption server for authentication of the sender.

8. The method of claim 1, wherein at least part of the transmitted message is hashed; the hashed part being accessible to the decryption server allowing confirmation of the authenticity of the transmitted message.

9. The method of claim 8, wherein said hashed part is previously encrypted.

10. The method of claim 8, wherein said hashed part is not encrypted.

11. The method of claim 1, wherein the message is encrypted by the sender with an encryption key and the corresponding decryption key is made available to the decryption server.

12. The method of claim 11, wherein the encryption and decryption keys are selected from the group comprising a symmetrical key pair and an asymmetrical key pair.

13. The method of claim 1, wherein the decryption server notifies the sender upon displaying the message to the recipient, thereby certifying that said message was delivered and displayed.

14. The method of claim 1 wherein at least one further piece of encrypted content is stored on at least one further internet address accessible to the decryption server, such that decryption is possible only after assembling all pieces of encrypted data.

15. The method of claim 1, wherein the step of authentication comprises comparing data sent in the uploaded data to the decryption server with data accessible to the decryption server.

16. Methods of safe email communication with a recipient, using data encryption but not requiring the recipient to have decryption software installed on his system, wherein the sender authenticates himself to the recipient, substantially as described herein.
